(19) United States
(12) Patent Application Publication
(10) Pub. No.: US 2003/0076643 A1
(43) Pub. Date: Apr. 24, 2003

(54) Over-current protection device

(76) Inventors: Edward Fu-Hua Chu, Taipei (TW); David Shau-Chew Wang, Taipei (TW); Yun-Ching Ma, Pingtung City (TW)

Correspondence Address: Harold V. Stotland, Seyfarth Shaw, 42nd Floor, 55 East Monroe Street, Chicago, IL, 60603-5803, US

(21) Appl. No.: 10/277,403

(22) Filed: Oct. 22, 2002

(30) Foreign Application Priority Data
Oct. 24, 2001 (TW) 090218191

(51) Int. Cl. H02H 9/08

(52) U.S. Cl. 361/93.9

(57) ABSTRACT

The present invention discloses an over-current protection device comprising at least one resistance component, outer conductive members and at least one insulation layer. The resistance component includes a current sensing element, a first conductive member and a second conductive member. The first conductive member is located on the surface of the current sensing element. The second conductive member is located on the other surface of the current sensing element. The resistance components that are adjacent use conductive buried holes to electrically connect their first conductive members and their second conductive member. The outer conductive member includes a first conductive end and a second conductive end. The first conductive end uses the conductive blind holes to electrically connect either the first or the second conductive member of the adjacent resistance component, and the second conductive end uses the conductive blind holes to electrically connect the other conductive member of the adjacent resistance component.

### BACKGROUND OF THE INVENTION

(A) Field of the Invention

The present invention relates to an over-current protection device, particularly to an over-current protection device with multi-layer circuits.

(B) Description of the Background Art

With the popular applications of portable electronic products nowadays, such as cellular phones, laptop computers, portable cameras and PDAs (“personal digital assistants”), how to prevent over-current or over-temperature situations is becoming more and more important.

The prior art over-current protection devices for batteries are of great variety, including thermal fuse, bimetal safety cutout, or PTC (positive temperature coefficient) over-current protection device. The PTC over-current protection device therein, featuring such advantages as reusability without replacement, thermal sensitivity and stable reliability, etc., has been widely applied in batteries for over-current protection, particularly in secondary batteries, such as Ni-MH batteries and lithium batteries.

PTC over-current protection device utilizes a conductive compound material with positive thermal coefficient for its current sensing element. As the resistance value of the PTC conductive compound material has sharp sensitivity toward temperature, under a normal operational condition, the resistance of the PTC over-current protection device can stay at very low value, thus allowing normal operation of the circuits. However, at time of over current or over temperature which results from improper use of the batteries, the resistance value of the PTC over-current protection device will rise suddenly, by tens of thousand times, to a high-resistance state (e.g. over 10⁴ ohm), while offsetting the excessive current in reverse, thus fulfilling the purpose of protecting the circuit components and the batteries.

A conventional over-current protection device, as illustrated in FIG. 1, consists of a resistance component 10, upper and lower insulation layers 104 and 105, and outer conductive members 106 and 107. The resistance component 10 includes a current sensing element 101, a first conductive member 102 and a second conductive member 103. On the surface of the first conductive member 102 and the second conductive member 103, there are insulated light-masking holes 108 and 108′, respectively. The two insulation layers 104 and 105 are located on the surface of the first conductive member 102 and the second conductive member 103, respectively, whilst the two outer conductive members 106 and 107 are located on the surface of the two insulation layers 104 and 105, respectively. The surfaces of the two outer conductive members can be etched to form two isolation areas 109, which separate the two outer conductive members 106 and 107 into two conductive ends. Finally, mechanic drilling is applied on the surface of the two outer conductive members 106 and 107 at the spots corresponding to where the two insulated light-masking holes 108 and 108′ are located to form two through holes 110 and 111. After that, the two through holes 110 and 111 are filled with conductive filling gel or processed by electroplating.

To be suitable for applications of SMT (Surface Mounting Technology), the first conductive member 102 and the second conductive member 103 have to be corresponding structures. As disclosed by an electric SMT device in U.S. Pat. No. 5,852,397, the first and second conductive members are drilled, electroplated and cut into semicircular through holes. In addition, as disclosed by an electric SMT device in U.S. Pat. No. 6,377,467, the device is formed by a multi-layer lamination, hole drilling, electroplating and cutting. However, the above-mentioned through holes obtained by mechanical drilling and electroplating not only take up space on the surface of the device, but also result in holes with relatively large diameters, making it practically impossible to decrease the size of device, whereas the stress incurred inside the device during the drilling causes bending of the structure of the device. Under the trends of decreasing the size of electronic device, with the device size being brought down from 0805 (length×width) to 0603, the diameter of the through holes also needs to be brought down accordingly. Nevertheless, the thickness of the cutting blade is even larger than the diameter of the through hole, or after cutting, the valid space left in the through hole is too small to proceed a soldering process.

Furthermore, as disclosed in U.S. Pat. No. 6,023,403, an electric SMT device uses full metal face instead of the method of hole drilling, electroplating and then cutting for its first and second conductive members. However, such a method using full metal face for small sized surface mounting devices requires the device to be cut prior to electroplating, so as to facilitate electroplating on the sides of the device. After cutting, the usable space left is reduced, and the device material becomes rather fragile and breaks off easily while being processed in the electroplating tanks, making processing rather difficult. Hence, such a method is not suitable for mounting devices small in size.

With the size of portable electronic products getting smaller and smaller, the inside components also need to be smaller. Therefore, the present invention is to provide a solution for this requirement.

### SUMMARY OF THE INVENTION

One object of the present invention is to provide an over-current protection device having conductive blind holes and buried holes for reducing the size of the over-current protection device in effective manner.

Another object of the present invention is to provide an over-current protection device using laser drilling or ion beam plasma etching technique to form micro via-holes with smaller diameter, so as to reduce the space previously needed for mechanical drilling and also to prevent the device from being distorted during the drilling because of the inner stress incurred.

To achieve the above-mentioned objects and avoid the disadvantages of prior art, the present invention discloses an over-current protection device comprising at least one resistance component, outer conductive members and at least one insulation layer. The resistance component includes a current sensing element, a first conductive member and a second conductive member. The first conductive member is located on the surface of the current sensing element. The second conductive member is located on the other surface of the current sensing element. The resistance components that are adjacent use conductive buried holes to electrically connect their first conductive members and their second conductive member. The outer conductive member includes a first conductive end and a second conductive end. The first conductive end uses the conductive blind holes to electrically connect either the first or the second conductive member of the adjacent resistance component, and the second conductive end uses the conductive blind holes to electrically connect the other conductive member of the adjacent resistance component. The insulation layer is used to insulate adjacent resistance components and to insulate the resistance components from the outer conductive members.

### BRIEF DESCRIPTION OF THE DRAWINGS

The present invention will be described according to the appended drawings in which:

FIG. 1 shows a cross-sectional diagram of prior art PTC over-current protection device;

FIGS. 2a to 2e show the flow chart of manufacturing the over-current protection device according to a first embodiment of the present invention;

FIG. 3 shows a cross-sectional diagram of an over-current protection device according to the first embodiment of the present invention;

FIGS. 4a to 4d show the flow chart of manufacturing the over-current protection device according to a second embodiment of the present invention; and

FIG. 5 shows a top view of the PTC plate of the present invention.

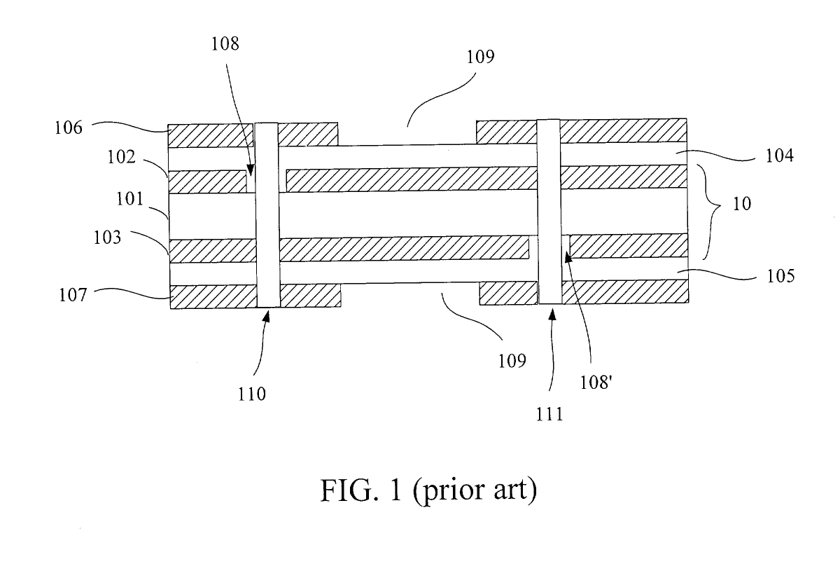

### PREFERRED EMBODIMENT OF THE PRESENT INVENTION

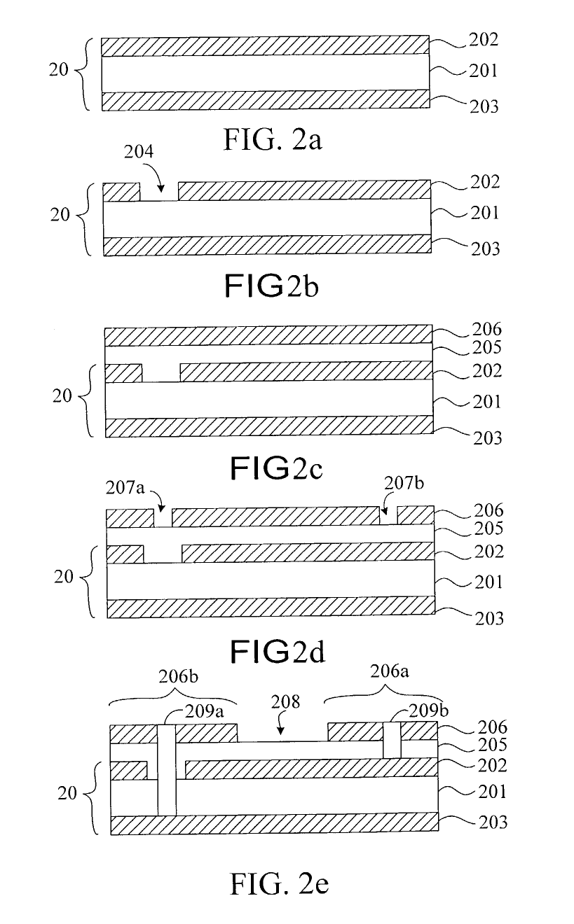

FIGS. 2a to 2e illustrate the flow chart of manufacturing the over-current protection device according to a first embodiment of the present invention. First, as illustrated in FIG. 2a, a resistance component 20 including a current sensing element 201, a first conductive member 202 and a second conductive member 203 is provided. The current sensing element 201 is made of a conductive compound material with positive thermal coefficient, having at least one type of polymer and conductive filler. The polymer can be crystalline or non-crystallize, and is selected from the group consisting of polyethylene, polypropylene, polyolefin, polypropylene acid, epoxy resin and their mixture thereof. The conductive filler is evenly distributed in the polymer. With the present invention adapting laser drilling technique, the conductive filler needs to select the conductive material that can be burned by laser, such as conductive carbon black, carbide or their mixture, wherein the carbide can be tungsten carbide or titanium carbide, etc. In addition, to increase the thermal sensibility and electric stability of the conductive compound, the conductive compound material can further include an additive, such as light starter, cross-linking agent, coupling agent, dispersant, stabilizer, anti-oxidant and non-conductive filler, etc. The first and second conductive members 202 and 203 can be made of metal foils, such as copper, nickel, zinc, silver, gold and their alloy thereof, and fabricated by means of electroplating, electroless plating or lamination techniques. Chemical etching is used to define the locations of the two conductive members.

As illustrated in FIG. 2b, by means of light exposing and developing procedures, an insulated light-masking hole 204 is etched on the first conductive member 202. Thereafter, the first conductive member 202 is covered with an insulation layer 205, and a third conductive member 206 is formed on top of the insulation layer 205, as illustrated in FIG. 2c. The third conductive member 206 is formed by means of electroplating, electroless plating or lamination. As illustrated in FIG. 2d, a first light-masking hole 207a and a second light-masking hole 207b can be formed by means of etching on the third conductive member 206, and the first light-masking hole 207a is aligned vertically with the insulated light-masking hole 204 of the first conductive member 202.

Moreover, as illustrated in FIG. 2e, an insulation area 208 is formed by means of etching on the third conductive member 206, which is divided into a first conductive end 206a and a second conductive end 206b. Thereafter, laser beam of carbon dioxide or ion plasma is applied through the first light-masking hole 207a and the second light-masking hole 207b, respectively, for etching the insulation layer 205 and the current sensing element 201 to form two micro via-holes, which then are filled with conductive gel or processed by electroplating or electroless plating, etc. to form the first and the second conductive micro via-holes 209a and 209b. Due to the first light-masking hole 207a being aligned vertically with the insulated light-masking hole 204, when processed through laser etching, the laser beam will penetrate through the insulation layer 205 and the current sensing element 201, whereby the first micro via-hole 209a can conduct the second conductive member 203 and the third conductive member 206. However, with laser applied at the second light-masking hole 207b being only able to penetrate through the insulation layer 205, the second micro via-hole 209b, therefore, can electrically connect the first conductive member 202 and the third conductive member 206. The structure of the above-mentioned over-current protection device shows that the micro via-holes 209a and 209b are located inside the over-current protection device, with one end of which having contact with the internal conductive members and the other end exposing externally for electrically connecting the internal conductive members and the external circuits, all together referred to as a conductive blind hole. Please note that the conductive blind holes of the present invention are different from the drilled holes structure of the conventional over-current protection device. Finally, the second conductive member 203 is covered with an insulating material (not illustrated in drawing) to complete a PTC plate. The outer conductive member of the PTC plate is etched to form a plurality of cutting lines (not illustrated in drawing), and the PTC plate is cut along the cutting lines to obtain a plurality of over-current protection devices.

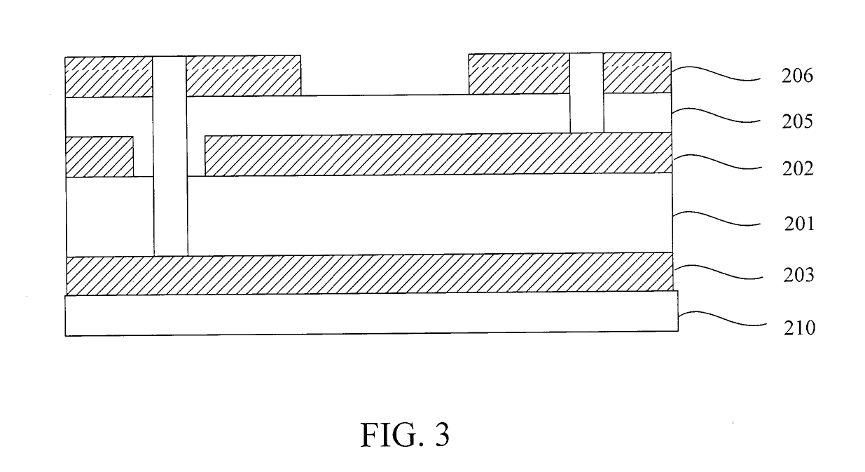

FIG. 3 shows a cross-sectional diagram of an over-current protection device according to the first embodiment of the present invention.

As the conventional through hole is obtained by mechanical drilling, it has a minimum diameter of 200-250 μm, whereas the micro via-holes of the present invention being accomplished by laser etching has a diameter smaller than 80 μm. Meanwhile, at about 2000 micro via-holes per minute, laser drilling works faster than the conventional mechanical drilling. This way, the present invention not only reduces the size of the over-current protection device, but also provides higher productivity.

Further, the over-current protection device of the present invention can include a rigidity reinforcing material for increasing the strength of its structure. Namely, the resistance component 20 that is provided, apart from including a current sensing element 201, the first conductive member 202 and the second conductive member 203, further includes a rigid insulator 210, such as FR4 glass fiber substrate. The rigid insulator 210 is installed on the other side of the second conductive member 203 opposite to the current sensing element 201, as illustrated in FIG. 3. The rigid insulator 201 can be formed by means of heat lamination to laminate the second conductive member 203.

Furthermore, the over-current protection device of the present invention can include two or more layers of resistance component, to achieve the effectiveness of parallel resistance, so as to lower the resistance of the over-current protection device and increase the working current.

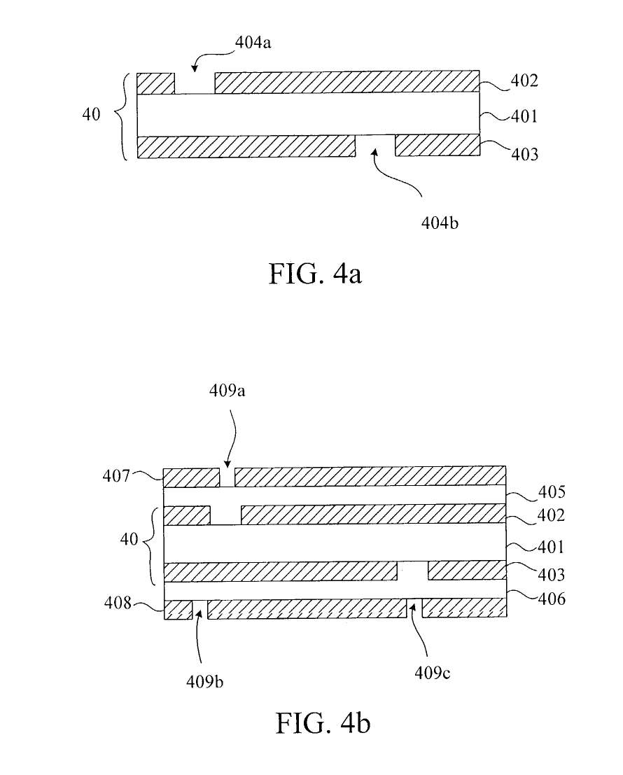

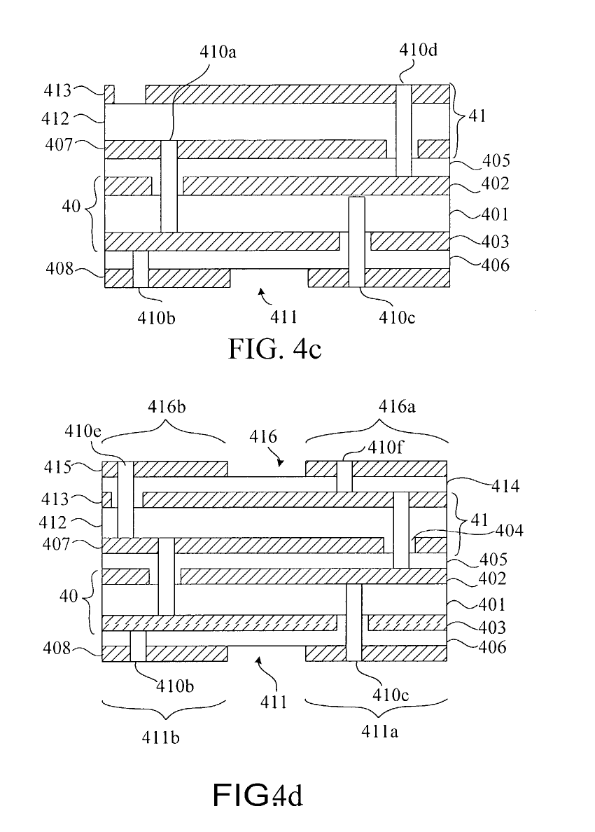

FIGS. 4a to 4d illustrate the flow chart of manufacturing the over-current protection device according to a second embodiment of the present invention, wherein parallel two-layered resistance components are utilized to lower the resistance of the over-current protection device to half of its original extent. As illustrated in FIG. 4a, a first resistance component 40 including a first current sensing element 401, the first conductive member 402 and the second conductive member 403 is provided, and a first insulated light-masking hole 404a and a second insulated light-masking hole 404b are formed by etching on the surface of the first conductive member 402.

Thereafter, as illustrated in FIG. 4b, a first insulation layer 405 is formed on the other side of the first conductive member 402 opposite to the first current sensing element 401, and a second insulation layer 406 is formed on the other side of the second conductive member 403 opposite to the first current sensing element 401, wherein the first and second insulation layers 405 and 406 can be formed by means of lamination or spreading techniques. Then, a third conductive member 407 and a fourth conductive member 408 are formed on the surface of the first and second insulation layers 405 and 406, respectively, wherein the third conductive member 407 and fourth conductive member 408 can be formed by means of lamination, electroplating or electroless plating. Thereafter, three light-masking holes 409a, 409b and 409c are formed by means of etching on the surface of the third conductive member 407 and second conductive member 403, wherein the light-masking hole 409a and 409c are aligned vertically with the first insulated light-masking hole 404a and the second insulated light-masking hole 404b.

Thereafter, as illustrated in FIG. 4c, laser beam of carbon dioxide is applied to penetrate through the light-masking holes 409a, 409b and 409c, burning the insulation layer 406, 405 and the current sensing element 401 to form three micro via-holes, which are then filled with conductive gel or processed through electroplating or electroless plating for becoming electricity conductive, thus forming the threes micro via-holes 410a, 410b and 410c. Afterward, etching is applied to form an insulated light-masking hole 404c on the surface of the third conductive member 407 and to form a conductivity isolation area 411 on the surface of the fourth conductive member 408. The surface of the third conductive member 407 is covered with a second current sensing element 412, which can be formed by means of spreading or layer-lamination. Thereafter, the surface of the second current sensing element 412 is covered with a fifth conductive member 413, which can be formed by means of lamination or electroplating. Subsequently, the second detecting component 412, the third conductive member 407 and the fifth conductive member 413 altogether form a second resistance component 41.

Similarly, the procedures of forming light-masking holes and the laser etching on the fifth conductive member 413 are applied in forming a micro via-hole 410d. Thereafter, the surface of the fifth conductive member 413 is covered with an insulation layer 414 and an outer conductive member 415, sequentially. The surface of the outer conductive component 415 is etched to form two light-masking holes 410e, 410f and an isolation area 416, and the light-masking holes are penetrated through by laser to form two micro via-holes which are then filled with conductive gel, or electroplated to become electricity conductive, thus forming two micro via-holes 410e and 410f, as illustrated in FIG. 4d. The isolation areas 411 and 416, respectively, are used to separate the fourth conductive member 408 and the outer conductive member 415 into two conductive ends 41la, 41lb and 416a, 416b, respectively, thus forming a PTC plate that is vertically and horizontally symmetrical and non-directional. Finally, the outer conductive member of the PTC plate is etched to form a plurality of cutting lines (not illustrated in drawing), and the PTC plate is cut along the cutting lines to obtain a plurality of over-current protection devices.

The whole structure of the over-current protection device shows that the micro via-holes 410b, 410c, 410e and 410f are located inside the over-current protection device, with one end of which having contact with the internal conductive members and the other end exposing externally outside the over-current protection device, while electrically connecting the internal conductive members and the external circuits, all together referred to as a conductive blind hole. On the contrary, the micro via-holes 410a and 410d, despite being located inside the over-current protection device, have contact with the internal conductive members with both ends, while electrically connecting the internal conductive members or resistance component, all together referred to as a conductive buried hole.

In the over-current protection device as disclosed in the present invention, the number of the resistance component layers can vary, depending on the needs, not only for lowering resistance, but also for reducing the size of the over-current protection device.

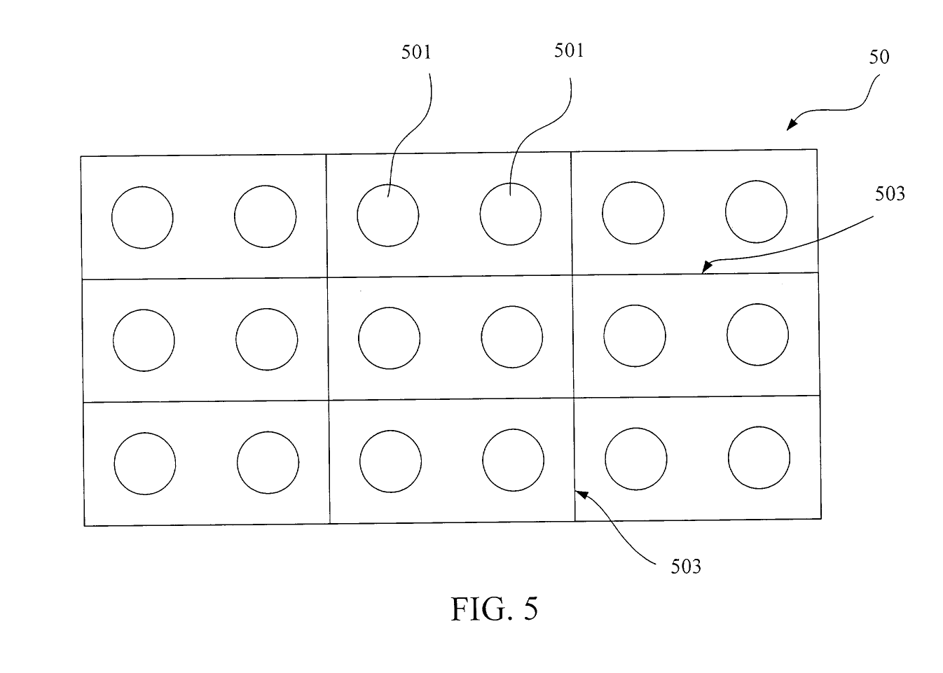

FIG. 5 shows a top view of the PTC plate 50 of the present invention. The PTC plate 50 comprises two or more layers of resistance components. Laser such as carbon dioxide can be utilized for pinpoint burning, or ion-beam etching on the surface of the outer conductive member, to form a plurality of micro via-holes 501. In addition, in proper locations on the surface of the outer conductive member, by means of etching, a plurality of cutting lines 503 can be formed to serve as basis for cutting. Finally, a plurality of over-current protection devices can be obtained by cutting along the cutting lines.

The above-described embodiments of the present invention are intended to be illustrated only. Numerous alternative embodiments may be devised by those skilled in the art without departing from the scope of the following claims.

What is claimed is:

1. An over-current protection device, comprising:
at least one resistance component, including:
(a) a current sensing element;
(b) a first conductive member disposed on a surface of the current sensing element;
(c) a second conductive member disposed on the surface of the current sensing element opposite to the first conductive member;
wherein the resistance components that are adjacent to each other use micro via-holes to electrically connect their first and second conductive members;
an outer conductive member, including:
(a) a first conductive end electrically connecting one of the first and the second conductive members of the adjacent resistance component by at least one micro via-hole; and
(b) a second conductive end insulated from the first conductive end, the second conductive end electrically connecting the other conductive member of the adjacent resistance component by at least one micro via-hole; and
an insulation layer for isolating adjacent resistance components and for isolating the resistance component from the outer conductive member.

2. The over-current protection device of claim 1, wherein the current sensing element is made of a conductive compound material with positive thermal coefficient.

3. The over-current protection device of claim 1, wherein the micro via-hole has a diameter smaller than 80 μm.

4. The over-current protection device of claim 1, wherein the micro via-hole is a conductive blind hole.

5. The over-current protection device of claim 1, wherein the micro via-hole is a conductive buried hole.

6. The over-current protection device of claim 1, wherein the micro via-hole is filled with conductive gel or processed by electroplating or electroless plating.

7. The over-current protection device of claim 1, further comprising a FR4 glass fiber substrate.

8. The over-current protection device of claim 1, wherein the micro via-hole is etched by a laser beam with low energy.

9. The over-current protection device of claim 1, wherein the micro via-hole is etched by an ion plasma.

10. The over-current protection device of claim 2, wherein the conductive compound material with positive thermal coefficient comprises a polymer and a conductive filler.

11. The over-current protection device of claim 10, wherein the polymer is crystalline or non-crystalline, selected from the group consisting of polyethylene, polypropylene, polyolefin, polypropylene acid, epoxy resin and their mixture thereof.

12. The over-current protection device of claim 10, wherein the conductive filler is selected from the group consisting of carbon black, carbide and their mixture.

13. The over-current protection device of claim 1, wherein the first and second conductive members are selected from the group consisting of copper, nickel, zinc, silver, gold and their alloy thereof.

14. An over-current protection device, comprising:
a resistance component, including:
(a) a current sensing element;
(b) a first conductive member disposed on a surface of the current sensing element;
(c) a second conductive member disposed on the surface of the current sensing element opposite to the first conductive member;
an outer conductive member, including:
(a) a first conductive end electrically connecting one of the first and the second conductive members of the resistance component by at least one micro via-hole; and
(b) a second conductive end insulated from the first conductive end, the second conductive end electrically connecting the other conductive member of the resistance component by at least one micro via-hole;
wherein the micro via-hole is etched by a laser beam with low energy or an ion plasma; and
an insulation layer for isolating the resistance component from the outer conductive member.

15. The over-current protection device of claim 14, wherein the current sensing element is made of a conductive compound material with positive thermal coefficient.

16. The over-current protection device of claim 14, wherein the micro via-hole has a diameter smaller than 80 μm.

17. The over-current protection device of claim 14, wherein the micro via-hole is a conductive blind hole or a conductive buried hole.

18. The over-current protection device of claim 14, wherein the micro via-hole is filled with conductive gel or processed by electroplating or electroless plating.

19. The over-current protection device of claim 14, further comprising a FR4 glass fiber substrate.
